(19) United States
(12) Patent Application Publication
(10) Pub. No.: US 2009/0150468 A1
(43) Pub. Date: Jun. 11, 2009

(54) DIGITAL FILTER

(75) Inventor: Robert Fifield, Redhill (GB)

Correspondence Address: SEED INTELLECTUAL PROPERTY LAW GROUP PLLC, 701 FIFTH AVENUE, SUITE 5400, SEATTLE, WA, 98104-7092, US

(73) Assignee: NXP B.V., Eindhoven (NL)

(21) Appl. No.: 11/996,300

(22) PCT Filed: Jul. 26, 2006
(86) PCT No.: PCT/IB2006/052562

§ 371 Date: Oct. 14, 2008

(30) Foreign Application Priority Data
Jul. 29, 2005 (EP) 05107017.5

(51) Int. Cl. G06F 17/10

(52) U.S. Cl. 708/301; 708/306

(57) ABSTRACT

A FIR filter (20) has a delay line comprising four delay elements (21a, 21b, 21c, 21d) for delaying a signal received at a filter input (22) and four multipliers (24a, 24b, 24c, 24d) for multiplying the delayed signals by respective partial filter coefficients a, b, c, d. The delay elements (21a, 21b, 21c, 21d) and multipliers (24a, 24b, 24c, 24d) are connected alternately in series. Four taps (23a, 23b, 23c, 23d) extract the signal from the delay line immediately after each of the delay elements (21a, 21b, 21c, 21d) and output the delayed, multiplied signals to an adder (25) for adding the delayed, multiplied signals to generate a filter output (26). The partial filter coefficients a, b, c, d effectively combine to implement filter coefficients A, B, C, D for the taps (23a, 23b, 23c, 23d), e.g. with A=a, B=a*b, C=a*b*c and D=a*b*c*d. Use of such partial filter coefficients a, b, c, d can significantly reduce the number of operations required for multiplication in the FIR filter (20) in comparison to the prior art.

This invention relates to a digital filter and to a method of digital filtering. Particular applications of the invention are a Finite Impulse Response (FIR) filter and a method of FIR filtering.

Digital filters are ubiquitous in digital circuits and digital signal processing. They are used to attenuate components of a signal in selected frequency ranges, which can help to reduce noise and interference. Finite Impulse Response (FIR) filters are a particular type of digital filter. Indeed, they are one of two main types of digital filter, the other main type being Infinite Impulse Response (IIR) filters. Their name is descriptive of their property that when a signal impulse is input to a FIR filter, the output will be finite, i.e. of limited length, which is a result of FIR filters not using any feedback. FIR filters are suited to a large number of applications. In particular, they are computationally efficient for so-called multi-rate applications, for example when a signal is interpolated or decimated to increase or decrease its sampling rate, as the finite nature of their output allows calculations not contributing to a decimated output, or calculations having predictable values in an interpolated output, to be omitted.

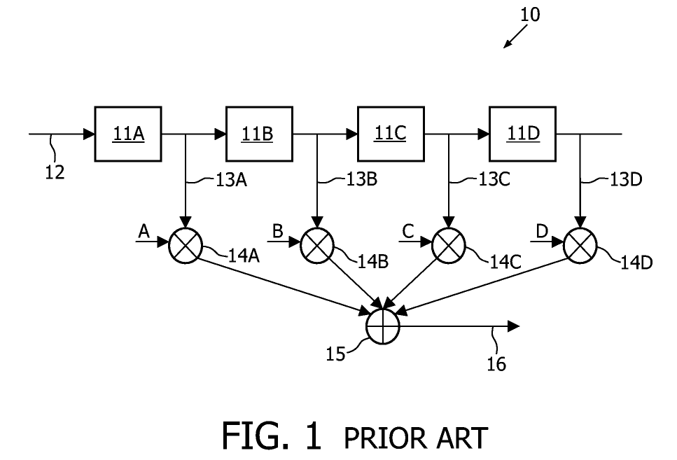

An example of a FIR filter of the prior art is shown in FIG. 1. This FIR filter 10 has a delay line comprising four delay elements 11A, 11B, 11C, 11D connected in series to a filter input 12 for inputting a signal to the filter 10. More specifically, the filter input 12 is connected to an input to a first delay element 11A; an output from the first delay element 11A is connected to an input to a second delay element 11B; an output from the second delay element 11B is connected to an input to a third delay element 11C; and an output from the third delay element 11C is connected to an input to a fourth delay element 11D. The filter 10 also has four taps 13A, 13B, 13C, 13D for extracting the signal from the delay line at points when it has different delays. Each of the taps 13A, 13B, 13C, 13D is connected to a point in the delay line at which the signal has a different delay. More specifically, a first tap 13A is connected to the output from the first delay element 11A; a second tap 13B is connected to the output from the second delay element 11B; a third tap 13C is connected to the output from the third delay element 11C; and a fourth tap 13D is connected to an output from the fourth delay element 11D. Each tap 13A, 13B, 13C, 13D has a multiplier 14A, 14B, 14C, 14D for multiplying the signals extracted from the delay line by a filter coefficient A, B, C, D. The filter coefficients A, B, C, D are selected according to the desired properties of the FIR filter 10, for example high pass, low pass or band pass and the precise frequency range of the stop band. The multipliers 14A, 14B, 14C, 14D are arranged in the taps 13A, 13B, 13C, 13D after the points at which the taps 13A, 13B, 13C, 13D extract the signal from the delay line. This means that the signal passes along the delay line unaffected by the multipliers 14A, 14B, 14C, 14D. The FIR filter 10 also has an adder 15 connected to outputs from each of the taps 13A, 13B, 13C, 13D (subsequent to the multipliers 14A, 14B, 14C, 14D) for adding the outputs from the taps 13A, 13B, 13C, 13D to generate a filter output 16.

In operation, a signal is input to the FIR filter 10 via the filter input 12. The first delay element 11A receives the signal from the input 12, delays it by a first given delay, which is typically one clock cycle, and outputs it to a second delay element 11B. The first tap 13A extracts the delayed signal from the delay line between the first delay element 11A and the second delay element 11B. The multiplier 14A of the first tap 13A multiplies the extracted, delayed signal by the first filter coefficient A and the first tap 13A outputs the extracted, delayed, multiplied signal to the adder 15. The second delay element 11B receives the delayed, unmultiplied signal from the first delay element 11A, delays it by a second given delay, again typically one clock cycle, and outputs the twice delayed signal to a third delay element 11C. The second tap 13B extracts the twice delayed signal from the delay line between the second delay element 11B and the third delay element 11C. The multiplier 14B of the second tap 13B multiplies the extracted, twice delayed signal by the second filter coefficient B and the second tap 13B outputs the extracted, twice delayed, multiplied signal to the adder 15. The third delay element 11C receives the twice delayed, unmultiplied signal from the second delay element 11B, delays it by a third given delay, again typically one clock cycle, and outputs the three times delayed signal to a fourth delay element 11. The third tap 13C extracts the three times delayed signal from the delay line between the third delay element 11C and the fourth delay element 11D. The multiplier 14C of the third tap 13C multiplies the extracted, three times delayed signal by the third filter coefficient C and the third tap 13C outputs the extracted, three times delayed, multiplied signal to the adder 15. The fourth delay element 11D receives the three times delayed, unmultiplied signal from the third delay element 11C, delays it by a fourth given delay, again typically one clock cycle, and outputs the four times delayed signal along the delay line. The fourth tap 13D extracts the four times delayed signal from the delay line after it is output from the fourth delay element 11D. The multiplier 14D of the fourth tap 13D multiplies the extracted, four times delayed signal by the fourth filter coefficient D and the fourth tap 13D outputs the extracted, four times delayed, multiplied signal to the adder 15. The adder 15 receives the variously extracted, delayed and multiplied signals from the taps 13A, 13B, 13C, 13D and adds them together to generate the filter output 16.

This FIR filter 10 operates adequately. However, many desirable sets of filter coefficients A, B, C, D are relatively large and the multipliers 14A, 14B, 14C, 14D use many operations to perform the required multiplications. This means that, when the FIR filter 10 is implemented in hardware, for example in an integrated circuit (IC), the multipliers 14A 14B, 14C, 14D can be slow relative to say the adder 15 and can contribute significantly to the power consumption of the FIR filter 10. Similarly, when the FIR filter 10 is implemented in software, for example code processed by a digital signal processor (DSP), the multipliers 14A 14B, 14C, 14D can contribute significantly to the number of processing steps required by the FIR filter 10. Schemes have therefore been developed to reduce the complexity of the multiplication required to be performed by FIR filters.

For example, the signal may be multiplied by another coefficient at the filter input 12. This effectively scales the signal extracted by each of the taps 13A, 13B, 13C, 13D and can reduce the complexity of the multiplication that needs to be performed by the multipliers 14A, 14B, 14C, 14D. However, this is effective for only certain combinations of filter coefficients A, B, C, D, for example when the filter coefficients A, B, C, D have one simple common mathematical factor that can be used as a scaling coefficient. If the filter coefficients A, B, C, D are unsuitable, this scheme can increase the overall complexity of the multiplication performed by the FIR filter 10. It is therefore desirable to find other ways of reducing the complexity of multiplication performed by digital filters.

According to a first aspect of the present invention there is provided a digital filter comprising a delay line having multiple delay elements for successively delaying a signal; taps for extracting the signal from the delay line at points when it has different delays; multipliers for multiplying the signal by respective coefficients; and an adder for adding outputs from the taps to generate a filter output, wherein at least one of the multipliers is arranged in the delay line between the points at which a respective pair of the taps extract the signal from the delay line.

Also, according to a second aspect of the present invention, there is provided a method of digital filtering comprising successively delaying a signal along a delay line; extracting the signal in taps from the delay line at points when it has different delays; multiplying the signal by coefficients; and adding outputs from the taps to generate a filter output, wherein at least one of the multiplications is performed in the delay line between the points at which a respective pair of the taps extract the signal from the delay line.

So, a multiplier may be arranged in the delay line. The coefficients of the multiplier in the delay line and any succeeding multipliers, for example in the taps, may therefore combine to implement equivalent conventional filter coefficients. In other words, cumulative multiplication can be used. However, positioning the multiplier in the delay line between two taps means that the signal extracted from the delay line by the tap or taps preceding the multiplier in the delay line can remain unaffected by the multiplier in the delay line. This allows a large number of different sets of filter coefficients to be implemented using the invention with reduced complexity. More generally, for many sets of filter coefficients, the overall number of operations required to perform multiplication in the filter can be significantly reduced and the digital filter and method of digital filtering of the invention can therefore be quicker and use less power than equivalent filters and methods of the prior art.

More than one of the multipliers may be arranged in the delay line. This can increase the extent to which cumulative multiplication is used to implement the filter coefficients and further reduce complexity. Several multipliers can be used together to implement a single equivalent conventional filter coefficient, with the coefficients of each multiplier combining to provide an equivalent conventional filter coefficient. Indeed, in a particularly preferred example of the invention, all of the multipliers may be arranged in the delay line before one or more of the points at which the taps extract the signal from the delay line. In other words, all of the multiplications may be performed in the delay line before one or more of the points at which the taps extract the signal from the delay line. This is particularly effective, as all but the last multiplier or multiplication in the delay line contributes to implementing more than one equivalent conventional filter coefficient.

On the other hand, flexibility is retained by arranging some of the multipliers in the taps. So, in another example of the invention, at least one of the multipliers may be arranged in a respective one of the taps after the point at which that tap extracts the signal from the delay line. Similarly, at least one of the multiplications may be performed in a respective one of the taps after the point at which that tap extracts the signal from the delay line. Indeed, in some cases, this can be useful even when a multiplier immediately precedes the point at which that tap extracts the signal from the delay line. More specifically, it might be preferred that at least one pair of the multipliers is arranged such that one of the pair of the multipliers is in the delay line between the point at which a respective one of the taps extracts the signal from the delay line and the point at which a respective other of the taps extracts the signal from the delay line with an immediately preceding delay, and the other of the pair of the multipliers is arranged in the respective one of the taps after the point at which that tap extracts the signal from the delay line. Similarly, it might be preferred that at least one pair of the multiplications is performed such that one of the pair of the multiplications is in the delay line between the point at which a respective one of the taps extracts the signal from the delay line and the point at which a respective other of the taps extracts the signal from the delay line with an immediately preceding delay, and the other of the pair of the multiplications is in the respective one of the taps after the point at which that tap extracts the signal from the delay line.

Other implementation details of the digital filter and method of digital filtering can be largely selected as desired. For example, conventional binary representation may be used, although it is preferred that the digital filter and method of digital filtering use canonic representation. Canonic or canonical (binary) representation, also known as Canonic Signed Digit (CSD) representation, uses a symbol for −1, as well as conventional symbols for 0 and 1 of binary representation. This can further reduce the number of operations required for multiplication.

The invention may be implemented in hardware or software. For example, the digital filter may comprise an integrated circuit (IC). Alternatively, the digital filter may comprise computer software for processing on suitable processing means, such as a digital signal processor (DSP). Indeed, according to a further aspect of the present invention, there is provided computer software or computer program code adapted to carry out the method described above when processed by processing means. The computer software or computer program code can be carried by a computer readable medium. The medium may be a physical storage medium such as a read only memory (ROM) chip. Alternatively, it may be a disk such as a Digital Versatile Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

The digital filter is typically a finite impulse response (FIR) filter. Similarly, the method of digital filtering is typically a method of FIR filtering.

Preferred embodiments of the invention will now be described, by way of example only, with reference to the accompanying drawings, in which:

FIG. 1 is a schematic illustration of a finite impulse response (FIR) filter of the prior art;

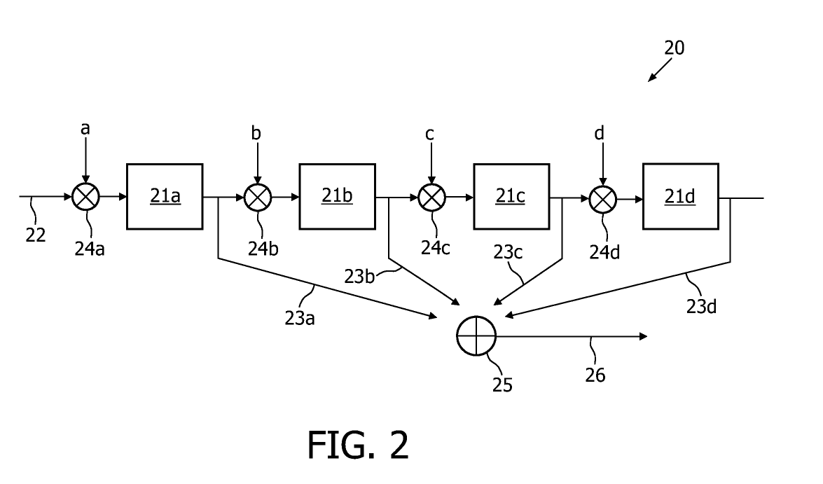

FIG. 2 is a schematic illustration of a FIR filter according to a first preferred embodiment of the invention; and

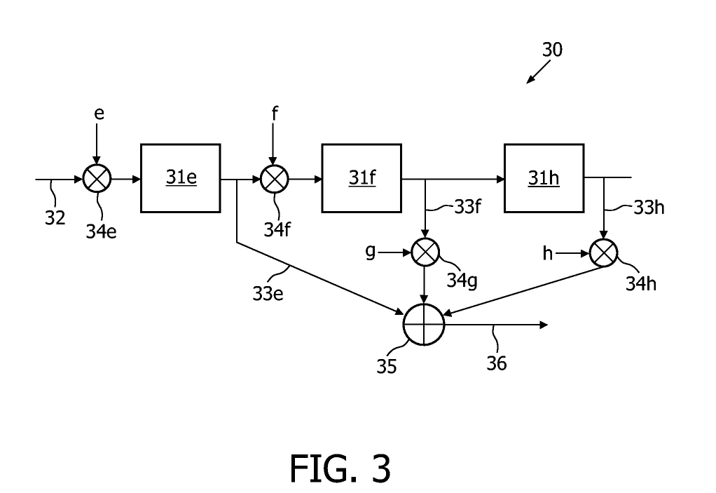

FIG. 3 is a schematic illustration of a FIR filter according to a second preferred embodiment of the invention.

Referring to FIG. 2, a finite impulse response (FIR) filter 20 according to a first preferred embodiment of the invention has a delay line comprising four delay elements 21a, 21b, 21c, 21d connected in series to a filter input 22 for inputting a signal to the filter 20. The filter 20 also has four multipliers 24a, 24b, 24c, 24d arranged in the delay line. More specifically, the filter input 22 is connected to an input to a first multiplier 24a; an output from the first multiplier 24a is connected to an input to a first delay element 21a; an output from the first delay element 21a is connected to an input to a second multiplier 24b; an output from the second multiplier 24b is connected to an input to a second delay element 21b; an output from the second delay element 21b is connected to an input to a third multiplier 24c; an output from the third multiplier 24c is connected to an input to a third delay element 21c; an output from the third delay element 21c is connected to an input to a fourth multiplier 24d; and an output from the fourth multiplier 24d is connected to an input to a fourth delay element 21d. The filter 20 also has four taps 23a, 23b, 23c, 23d for extracting the signal from the delay line at points when it has different delays. Each of the taps 23a, 23b, 23c, 23d is connected to a point in the delay line at which the signal has a different delay. More specifically, a first tap 23a is connected to the output from the first delay element 21a; a second tap 23b is connected to the output from the second delay element 21b; a third tap 23c is connected to the output from the third delay element 21c; and a fourth tap 23d is connected to an output from the fourth delay element 21d. An adder 25 is connected to outputs from the taps 23a, 23b, 23c, 23d for adding the outputs from the taps 23a, 23b, 23c, 23d to generate a filter output 26.

Each multiplier 24a, 24b, 24c, 24d is arranged to multiply the signal by a respective partial filter coefficient a, b, c, d. The multipliers 24a, 24b, 24c, 24d are arranged in relation to the taps 23a, 23b, 23c, 23d such that the partial filter coefficients a, b, c, d combine to provide equivalent conventional filter coefficients A, B, C, D for the respective taps 23a, 23b, 23c, 23d. These equivalent conventional filter coefficients A, B, C, D are selected according to the desired properties of the FIR filter 20, for example high pass, low pass or band pass and the precise frequency range of the stop band, in a conventional way. More specifically, as mentioned above, the multipliers 24a, 24b, 24c, 24d are all arranged in the delay line. The point at which the first tap 23a extracts the signal from the delay line is preceded in the delay line by only the first multiplier 24a (and the first delay element 21a). The point at which the second tap 23b extracts the signal from the delay line is preceded in the delay line by only the first and second multipliers 24a, 24b (and the first and second delay elements 21a, 21b). The point at which the third tap 23c extracts the signal from the delay line is preceded in the delay line by only the first, second and third multipliers 24a, 24b, 24c (and the first, second and third delay elements 21a, 21b, 21c). Finally, the point at which the fourth tap 23d extracts the signal from the delay line is preceded in the delay line by all of the first, second, third and fourth multipliers 24a, 24b, 24c, 24d (and all of the first, second, third and fourth delay elements 21a, 21b, 21c, 21d). This means that the partial filter coefficients combine as follows to provide equivalent conventional filter coefficients A, B, C, D for the respective taps 23a, 23b, 23c, 23d: A=a, B=a*b, C=a*b*c, and D=a*b*c*d.

In operation, a signal is input to the filter 20 via the filter input 22. The first multiplier 24a multiplies the signal by the first partial filter coefficient a and outputs it to the first delay element 21a. The first delay element 21a receives the multiplied signal from the first multiplier 24a, delays it by a first given delay, which is typically one clock cycle, and outputs it to the second multiplier 24b. The first tap 23a extracts the multiplied, delayed signal from the delay line between the first delay element 21a and the second multiplier 24b and outputs it to the adder 25. The second multiplier 24b multiplies the delayed, multiplied signal by the second partial filter coefficient b and outputs it to the second delay element 21b. The second delay element 21b receives the delayed, twice multiplied signal from the second multiplier 24b, delays it by a second given delay, again typically one clock cycle, and outputs the it to the third multiplier 24c. The second tap 23b extracts the twice multiplied, twice delayed signal from the delay line between the second delay element 21b and the third multiplier 24c and outputs it to the adder 25. The third multiplier 24c multiplies the twice multiplied, twice delayed signal by the third partial filter coefficient c and outputs it to the third delay element 21c. The third delay element 21c receives the three times multiplied, twice delayed signal from the third multiplier 24c, delays it by a third given delay, again typically one clock cycle, and outputs it to the fourth multiplier 23d. The third tap 23c extracts the three times multiplied, three times delayed signal from the delay line between the third delay element 21c and the fourth multiplier 24d and outputs it to the adder 25. The fourth multiplier 24d multiplies the three times multiplied, three times delayed signal by the fourth partial filter coefficient d and outputs it to the fourth delay element 21d. The fourth delay element 21d receives the four times multiplied, three times delayed signal from the fourth multiplier 24d, delays the signal by a fourth given delay, again typically one clock cycle, and outputs it along the delay line. The fourth tap 23d extracts the four times multiplied, four times delayed signal from the delay line after the fourth delay element 21d and outputs it to the adder 25. The adder 25 receives the variously extracted, delayed and multiplied signals from the taps 23a, 23b, 23c, 23d and adds them together to generate filter output 26.

It is helpful to consider operation of the FIR filter 20 of the first preferred embodiment of the invention in comparison to operation of the FIR filter 10 of the prior art for particular filter coefficients A, B, C, D. In this example, the four filter coefficients A, B, C, D are selected to have values A=7, B=−21, C=189 and D=945. Looking at the FIR filter 10 of the prior art first, in canonic representation (with −1 expressed as X), these filter coefficients A, B, C, D are expressed as, and require the following number of operations to be performed by the respective multipliers 14A, 14B, 14C, 14D

| | | |
|---|---|---|
| A = 7 = | 0000000100X = | 2 operations |
| B = −21 = | 00000X01011 = | 4 operations |
| C = 189 = | 00011000X01 = | 4 operations |
| D = 945 = | 100X0110001 = | 5 operations |

In other words, a total of 15 operations are required for multiplication in the FIR filter 10 of the prior art for the filter coefficients A=7, B=−21, C=189 and D=945.

The number of operations can be significantly reduced by using the FIR filter 20 of the first preferred embodiment of the invention. Here, partial filter coefficients a=7, b=−3, c=−9 and d=5 combine to implement equivalent conventional filter coefficients A=7, B=−21, C=189 and D=945. More specifically, A=a gives 7=7, B=a*b gives −21=7*−3, C=a*b*c gives 189=7*−3*−9, and D=a*b*c*d gives 945=7*−3*−9*5. Again using canonic representation, the partial filter coefficients a, b, c, d are expressed as, and require the following number of operations to be performed by the respective multipliers 24a, 24b, 24c, 24d

| a = 7 = | 0100X = | 2 operations |
|---|---|---|
| b = −3 = | 00X01 = | 2 operations |
| c = −9 = | 1100X = | 3 operations |
| d = 5 = | 00101 = | 2 operations |

In other words, a total of 9 operations are required for multiplication in the FIR filter 20 of the first preferred embodiment of the invention for the equivalent conventional filter coefficients A=7, B=−21, C=189 and D=945. This offers considerable savings in computational complexity and ultimately the FIR filter 20 of the first preferred embodiment of the invention is significantly quicker and uses less power than the FIR filter 10 of the prior art.

The invention is not limited to the architecture of the FIR filter 20 of the first preferred embodiment of the invention. In particular, the positions and numbers of the multipliers 24a, 24b, 24c, 24d can be varied to suit different equivalent conventional filter coefficients A, B, C, D. For example, referring to FIG. 3, a FIR filter 30 according to a second preferred embodiment of the invention has a delay line comprising three delay elements 31e, 31f, 31h. It also has three taps 33e, 33f, 33h, but has four multipliers 34e, 33f, 33g, 33h. Two of the multipliers 34e, 33f are arranged in the delay line and two of the multipliers 34g, 34h are arranged in respective taps 33f, 33h. More specifically, a filter input 32 is connected to an input to a first multiplier 34e; an output from the first multiplier 34e is connected to an input to a first delay element 31e; an output from the first delay element 31e is connected to an input to a second multiplier 34f; an output from the second multiplier 34f is connected to an input to a second delay element 31f; and an output from the second delay element 31f is connected to an input to a third delay element 31h. Each of the taps 33e, 33f, 33h is connected to a point in the delay line at which the signal has a different delay. More specifically, a first tap 33e is connected to the output from the first delay element 31e; a second tap 33f is connected to the output of the second delay element 33f; and a third tap 33h is connected to an output of the third delay element 33h. The second tap 33f incorporates a third multiplier 34g and the third tap 33h incorporates a fourth multiplier 34h. So, whereas the first and second multipliers 34e, 34f are arranged in the delay line, the third and fourth multipliers 34g, 34h are arranged in the second and third taps 33f, 33h respectively, after the points at which the taps 33f, 33h extract the signal from the delay line.

Each multiplier 33e, 33f, 33g, 33h is arranged to multiply the signal by a respective partial filter coefficient e, f, g, h. The multipliers 33e, 33f, 33g, 33h are arranged such that the partial filter coefficients combine to provide equivalent conventional filter coefficients E, F, G. These equivalent conventional filter coefficients E, F, G are again selected according to the desired properties of the FIR filter 30, for example high pass, low pass or band pass and the precise frequency range of the stop band, in a conventional way. More specifically, the point at which the first tap 33e extracts the signal from the delay line is preceded in the delay line by only the first multiplier 34e (and the first delay element 31e). The point at which the second tap 33f extracts the signal from the delay line is preceded in the delay line by only the first and second multipliers 34e, 34f (and the first and second delay elements 31e, 31f) and the second tap 33f incorporates the third multiplier 34g. The point at which the third tap 33h extracts the signal from the delay line is preceded in the delay line again by only the first and second multipliers 34e, 34f (and by all of the first, second and third delay elements 31e, 31f, 31h) and the third tap incorporates the fourth multiplier. This means that the partial filter coefficients e, f, g, h combine as follows to provide equivalent conventional filter coefficients E, F, G for the taps 33e, 33f, 33h: E=e, F=e*f*g and G=e*f*h.

In operation, a signal is input to the filter 30 via the filter input 32. The first multiplier 34e multiplies the signal by the first partial filter coefficient e and outputs it to the first delay element 31e. The first delay element 31e receives the multiplied signal from the first multiplier 34e, delays it by a first given delay, which is typically one clock cycle, and outputs it to the second multiplier 34f. The first tap 33e extracts the multiplied, delayed signal from the delay line between the first delay element 31e and the second multiplier 34f and outputs it to the adder 35. The second multiplier 34f multiplies the multiplied, delayed signal by the second partial filter coefficient f and outputs it to the second delay element 31f. The second delay element 31f receives the twice multiplied, delayed signal from the second multiplier 34f, delays it by a second given delay, again typically one clock cycle, and outputs the it to the third delay element 31h. The second tap 33f extracts twice multiplied, twice delayed signal from the delay line between the second delay element 31f and the third delay element 31g, the third multiplier 34g of the second tap 33f multiplies the twice multiplied, twice delayed signal by the third partial filter coefficient g and the tap 33f outputs it to the adder 35. The third delay element 31h receives the twice delayed, twice multiplied signal from the second delay element 31f, delays it by a third given delay, again typically one clock cycle, and outputs it along the delay line. The third tap 33h extracts the twice multiplied, three times delayed signal from the delay line after the third delay element 31h, the fourth multiplier 34h of the third tap 33h multiplies the twice multiplied, three times delayed signal by the fourth partial filter coefficient h and the tap 33h outputs it to the adder 35. The adder 35 receives the variously delayed and multiplied signals from the taps 33e, 33f, 33h and adds them together to generate filter output 36.

The described embodiments of the invention are only examples of how the invention may be implemented. Modifications, variations and changes to the described embodiments will occur to those having appropriate skills and knowledge. These modifications, variations and changes may be made without departure from the spirit and scope of the invention defined in the claims and its equivalents.

The inclusion of reference signs in parentheses in the claims is intended to aid understanding and is not intended to be limiting.

In the present specification and claims the word “a” or “an” preceding an element does not exclude the presence of a plurality of such elements. Further, the word “comprising” does not exclude the presence of other elements or steps than those listed.

1. A digital filter comprising a delay line having multiple delay elements for successively delaying a signal; taps for extracting the signal from the delay line at points when it has different delays; multipliers for multiplying the signal by respective coefficients and an adder for adding outputs from the taps to generate a filter output, wherein at least one of the multipliers is arranged in the delay line between the points at which a respective pair of the taps extract the signal from the delay line.

2. The digital filter of claim 1, wherein all of the multipliers are arranged in the delay line before one or more of the points at which the taps extract the signal from the delay line.

3. The digital filter of claim 1, wherein at least one of the multipliers is arranged in a respective one of the taps after the point at which that tap extracts the signal from the delay line.

4. The digital filter of claim 1, wherein at least one pair of the multipliers is arranged such that one of the pair of the multipliers is in the delay line between the point at which a respective one of the taps extracts the signal from the delay line and the point at which a respective other of the taps extracts the signal from the delay line with an immediately preceding delay, and the other of the pair of the multipliers is in the respective one of the taps after the point at which that tap extracts the signal from the delay line.

5. The digital filter of claim 1, using canonic representation.

6. A finite impulse response (FIR) filter according to claim 1.

7. A method of digital filtering comprising successively delaying a signal along a delay line; extracting the signal in taps from the delay line at points when it has different delays; multiplying the signal by coefficients; and adding outputs from the taps to generate a filter output, wherein at least one of the multiplications is performed in the delay line between the points at which a respective pair of the taps extract the signal from the delay line.

8. The method of claim 7, wherein all of the multiplications are performed in the delay line before one or more of the points at which the taps extract the signal from the delay line.

9. The method of claim 7, wherein at least one of the multiplications is performed in a respective one of the taps after the point at which that tap extracts the signal from the delay line.

10. The method of claim 7, wherein at least one pair of the multiplications is performed such that one of the pair of the multiplications is in the delay line between the point at which a respective one of the taps extracts the signal from the delay line and the point at which a respective other of the taps extracts the signal from the delay line with an immediately preceding delay, and the other of the pair of the multiplications is in the respective one of the taps after the point at which that tap extracts the signal from the delay line.

11. The method of claim 7, using canonic representation.

12. A method of finite impulse response filtering according to claim 7.

13. Computer software adapted to carry out the method of claim 7 when processed by computer processing means.
